(19) United States
(12) Patent Application Publication
(10) Pub. No.: US 2011/0300744 A1
(43) Pub. Date: Dec. 8, 2011

(54) E-Z RETRACTABLE CORD SYSTEM

(76) Inventor: John R. Garry, Itasca, IL (US)

(21) Appl. No.: 13/149,296

(22) Filed: May 31, 2011

Related U.S. Application Data
(60) Provisional application No. 61/352,163, filed on Jun. 7, 2010.

(51) Int. Cl. H01R 13/72

(52) U.S. Cl. 439/501

(57) ABSTRACT

A retractable extension power cord comprising: a plastic, circular (cylindrical) housing having at least a first and a second outlet; a spooler for holding power cord; a retractable power cord having a male end retractable out of a first outlet and a female end accessible out of a second outlet, a mounting bracket mountable onto a vertical or horizontal surface; and a ground fault circuit interrupter. The male end is directly connectable to a receptacle while the female end is directly or indirectly connectable to a power source. The retractable power cord communicates power between the male end and the female end The retractable extension power cord provide a means for neatly storing and organizing extension cords while also providing retracting and reverse-retracting capabilities during in-use and non-use periods. Further, the retractable extension cord is reversible and lockable.

### CROSS-REFERENCE TO RELATED APPLICATION

The present application is related to and claims priority from prior provisional application Ser. No. 61/352,163, filed Jun. 7, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of cords and more specifically relates to retractable cord devices and systems.

### 2. DESCRIPTION OF THE RELATED ART

An extension cord is an insulated, flexible electric wire typically fitted with a plug at one end and one or more outlets on the other, permitting a user to plug in devices whose cords are not long enough to reach a wall outlet. Extension cords come in various lengths and thicknesses, and service duties. In general, the more power needed by the appliance, the thicker the cord should be to meet that demand to avoid over-heating of the cord. Cords to be used outdoors, in wet areas, around oils, or exposed to sunlight for long periods should be selected for such specific service. Due to the extended length of some extension cords, tangling may occur. Further, a user may trip over the cord potentially causing a hazardous condition.

Many times extension cords may be used to communicate electricity to appliances near water. This may create a dangerous condition because individuals can get electrocuted. It is desirable that these conditions would be avoided to promote user-safety, yet allow these appliances to be powered, as needed.

Various attempts have been made to solve problems found in retractable cord art. Among these are found in: U.S. Pat. No. 5,700,150 to Morin; U.S. Pat. No. 6,439,360 to Miller; U.S. Pat. No. 6,848,937 to Hsiao; and U.S. Pat. No. 6,854,575 to Desormeaux. This prior art is representative of retractable cords.

Ideally, E-Z Retractable cord system should be user-friendly and yet, would operate reliably and be manufactured at a modest expense. Therefore a need exists for an extension cord for neatly storing and organizing an extension cord(s) while also providing retracting and reverse-retracting capabilities and to avoid the above-mentioned problems.

### BRIEF SUMMARY OF THE INVENTION

In view of the foregoing disadvantages inherent in the known retractable cord art, the present invention provides a novel E-Z retractable cord. The general purpose of the present invention, which will be described subsequently in greater detail, is to provide a device for neatly storing and organizing extension cords while also providing retracting and reverse-retracting capabilities.

The present invention, E-Z retractable cord system as disclosed herein preferably comprises: a plastic, circular housing having at least a first and a second outlet (for allowing the male end of the cord to be retracted/accessed in and out of the housing). Further, the male end is directly (or indirectly) connectable to a receptacle such as a boat, golf cart, or electric car, while the female end is directly or indirectly connectable to a power source. The overall length of the retractable power cord is defined by the male end and the female end. Additionally, the retractable power cord communicates power between the male end and the female end.

The ground fault circuit interrupter effectively prevents output short circuit(s) from drawing excessive current along with detecting current leakage. The ground fault circuit interrupter interrupts a circuit in preferred embodiments if the current leakage exceeds a range of 4-6 mA of current within 25 ms.

A kit is also embodied herein for the E-Z retractable cord system system comprising: at least one retractable extension power cord; at least one mounting bracket; fastening means; and a set of user instructions. In certain embodiments different gauges of retractable extension power cords may be used.

In accordance with the embodiments of the present invention a preferred method of use is disclosed herein comprising: mounting a mounting bracket onto a flat surface; retracting a male end of a power cord out of a first outlet; removably connecting the male end to a receptacle; removably connecting the female end to a power source; and turning the retractable extension power cord system on to power the receptacle.

The present invention holds significant improvements and serves as an E-Z retractable cord system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, E-Z retractable cord, constructed and operative according to the teachings of the present invention.

FIG. 1 shows a perspective view illustrating an E-Z Retractable cord system in an ‘in-use’ condition according to an embodiment of the present invention.

FIG. 2 shows a perspective view illustrating a retractable extension power cord of the E-Z Retractable cord system according to an embodiment of the present invention.

FIG. 3A is another perspective view illustrating a receptacle of the E-Z Retractable cord system according to an embodiment of the present invention.

FIG. 3B is another perspective view illustrating the receptacle of the E-Z Retractable cord system according to an embodiment of the present invention.

FIG. 4 is another perspective view illustrating the retractable extension power cord in an extended position of the E-Z Retractable cord system according to an embodiment of the present invention.

FIG. 5 is a flowchart illustrating a method of use for the E-Z Retractable cord system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a retractable cord device and more specifically relates to an E-Z Retractable Cord as used to keep cords neatly stored and out of the way with reverse-retractable capabilities thereby effectively preventing tangled and jumbled cords while also enhancing accessibility.

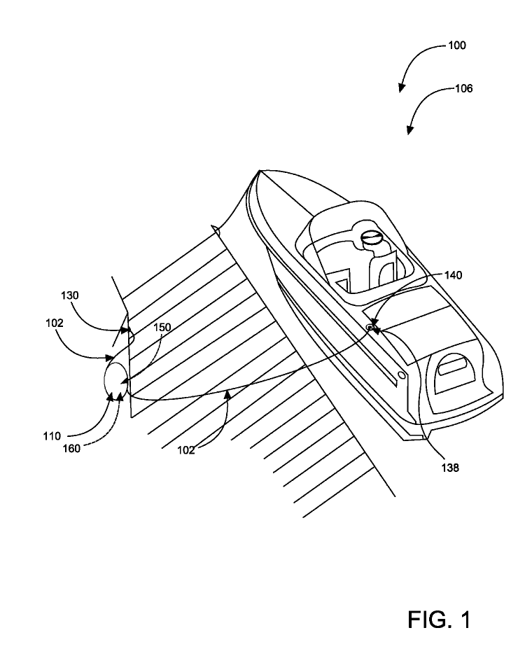

Referring now to FIG. 1 showing a perspective view of E-Z Retractable cord system 100 in ‘in-use’ condition 106 according to an embodiment of the present invention. As shown in FIG. 1, E-Z Retractable cord system 100 may be used on marine vehicles such as boat 190 as illustrated in ‘in-use condition 106. However, E-Z Retractable cord system 100 may be used on a wide variety of (non-land and land) vehicles in addition to boat 190. These vehicles may include but are not limited to fishing boats for re-charging batteries of a trolling motor, a golf cart, electronics in RV's, and block heaters in school buses, electric/hybrid cars, and semi-trucks or the like.

E-Z Retractable cord system 100 preferably comprises retractable extension power cord 102. Further, retractable extension power cord 102 may offer a more efficient means of managing this retractable extension power cord 102 while also effectively ensuring retractable extension power cord(s) 102 are preferably readily within reach at all times. Easily mounted, E-Z Retractable Cord system 100 may ensure that consumers and professional never forget retractable extension power cord 102, and effectively eliminate the risks that necessary equipment may lose power. Additionally the present invention provides an efficient storage means for retractable extension power cord 102.

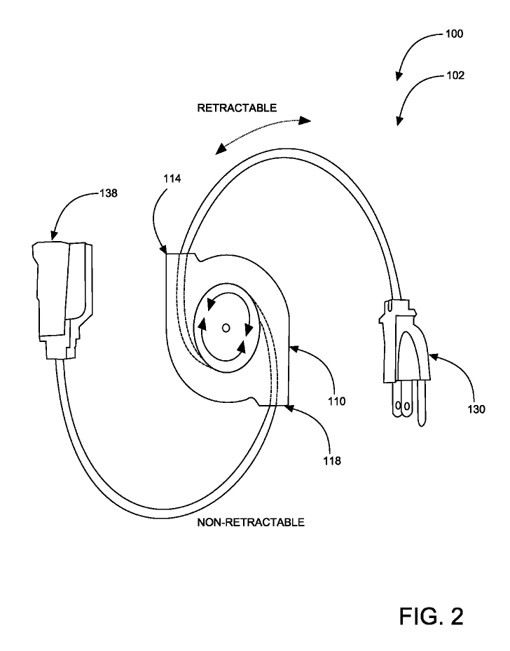

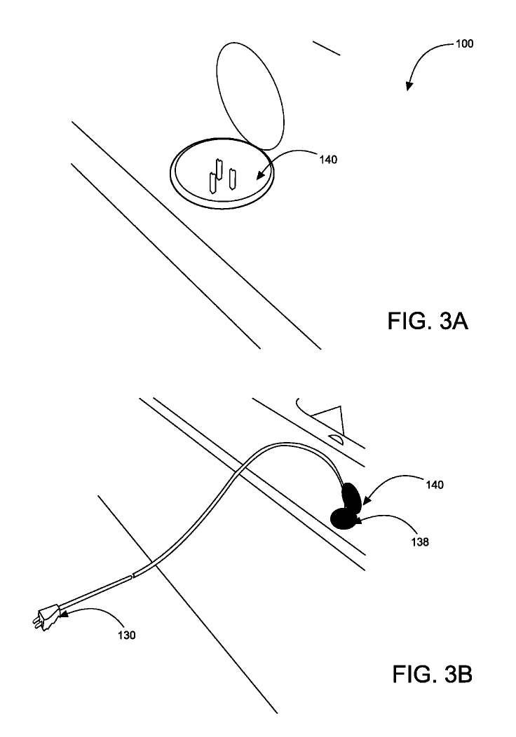

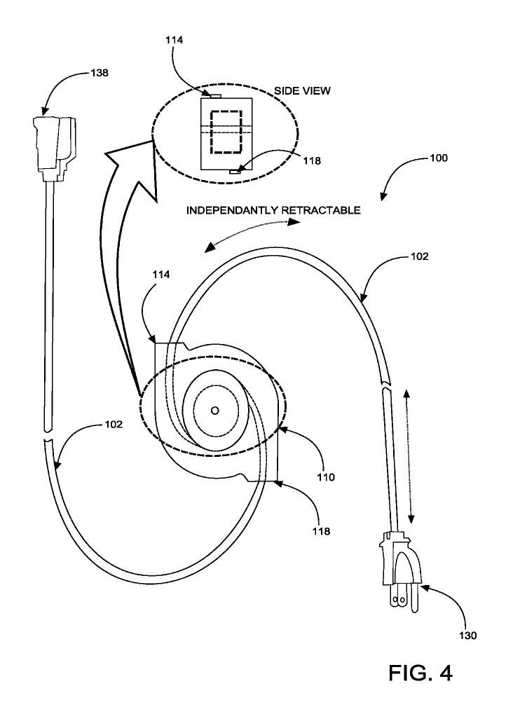

Referring now to FIGS. 2-4 showing perspective views of retractable extension power cord 102 according to embodiment(s) of the present invention. Retractable extension power cord 102 preferably includes housing 110 having at least first outlet 114 and second outlet 118. Each of male end 130 and female end 138 preferably are independently accessible out of first outlet 114 and second outlet 118, respectively as described previously. Female end 138 comprises a short (preferably) non-retractable whip. Male end 130 may be retracted out of first outlet 114 and/or into first outlet 114 repeatedly. Housing 110 is preferably (substantially) circular (cylindrical) and may comprise plastic material. Upon reading this specification, it should be appreciated that, under appropriate circumstances, considering such issues as user preferences, design preference, structural requirements, marketing preferences, cost, available materials, technological advances, etc., other materials for housing 110 may be used such as, for example, fiberglass, composite(s), aluminum, alloys, various plastics or combinations thereof, etc., may be sufficient.

Retractable extension power cord 102 is preferably reversible and lockable. Male end 130 of retractable extension power cord 102 may be retractable out of first outlet 114, as mentioned previously. It is preferable that female end 138 is not retractable, but may be independently retractable in other embodiments. Retractable extension cord 102 may also include mounting bracket 150. Mounting bracket 150 is preferably mountable onto a substantially vertical surface or may also be mountable on a substantially horizontal surface. Additionally, mounting bracket 150 is located on a posterior region of housing 110 thereby effectively aesthetically-concealing mounting bracket 150 when mounted on either a horizontal or vertical surface. This provides a convenient means for hanging the device during in-use and non-use periods.

Retractable extension power cord 102 preferably further comprises ground fault circuit interrupter 160. Ground fault circuit interrupter 160 comprises an electrical wiring device that disconnects a circuit whenever it detects that the electric current is not balanced between the energized conductor and the return neutral conductor. If the energized conductor and the return neutral conductor do not sum to zero, there is a leakage of current to somewhere else (to earth/ground, or to another circuit), and the device will open its contacts. Such an imbalance is sometimes caused by current leakage through the body of a person who is grounded and accidentally touching the energized part of the circuit. A lethal shock can result from these conditions. Ground fault circuit interrupter 160 may be designed to disconnect quickly enough to mitigate the harm caused by such shocks although ground fault circuit interrupter 160 is not intended to provide protection against overload or short-circuit conditions. In this way the present invention is made safe for use around water or other fluids that may be conductive.

Ground fault circuit interrupter 160 may also interrupt a circuit if the current leakage exceeds a range of for example 4-6 mA of current within 25 ms. Ground fault circuit interrupter 160 is preferably designed to prevent electrocution by detecting the leakage current, which can be far smaller (typically 5-30 milliamperes) than the currents needed to operate conventional circuit breakers or fuses requiring several amperes. Ground fault circuit interrupter 160 within the present invention is intended to operate within 25-40 milliseconds, before electric shock can drive the heart into ventricular fibrillation, the most common cause of death through electric shock. Further, the equipment is also protected from harm with this unique feature.

E-Z Retractable cord system 100 according to an embodiment of the present invention of FIGS. 1-4 may comprise kit 440. Kit 440 may comprise the following parts: at least one retractable extension power cord 102; at least one mounting bracket 150; fastening means; and a set of user instructions. Optionally, E-Z Retractable cord system 100 may comprise a plurality of retractable extension power cords 102 that may be ran in series or parallel relationships. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately.

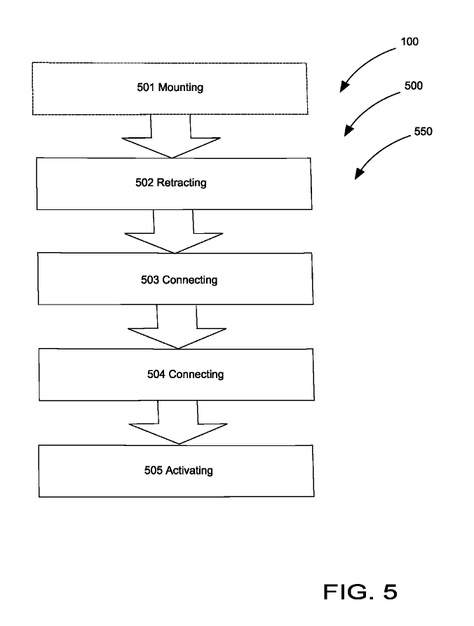

FIG. 5. shows flowchart 550 illustrating method of use 500 according to an embodiment of the present invention of FIGS. 1-4. A method of using (at least herein enabling method of use 500) E-Z Retractable cord system 100 may comprise the steps of: step one 501 mounting (or otherwise fastening/securing) mounting bracket 150 onto a flat surface; step two 502 retracting male end 130 of retractable extension power cord 102 out of first outlet 114; step three 503 removably connecting male end 130 to receptacle 140; step four 504 removably connecting female end 138 to a power source; and step five 505 turning (activating) on retractable extension power cord system 102 on to provide power to power receptacle 140.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A retractable extension power cord system comprising:
a housing having at least a first and a second outlet;
wherein said male end is accessible and retractable out of said first outlet;
wherein said female end is accessible out of said second outlet;
wherein said male end is directly connectable to a receptacle;
wherein said female end is directly or indirectly connectable to a power source;
wherein overall length of said retractable power cord is defined by said male end and said female end and varies according to user-desired length;
wherein said retractable power cord communicates power between said male end and said female end; and
wherein said retractable power cord as attached to said male end and said female end, said male end retractable to a desired user-preferred length and said female end able to removably plug to said power source.

2. The retractable extension power cord system of claim 1 wherein said housing is circular and comprises plastic.

3. The retractable extension power cord system of claim 1 wherein said housing comprises fiberglass.

3. The retractable extension power cord system of claim 1 wherein said housing comprises carbon fiber composite.

4. The retractable extension power cord system of claim 1 wherein said housing comprises aluminum.

5. The retractable extension power cord system of claim 1 wherein said retractable extension cord is reversible.

6. The retractable extension power cord system of claim 1 wherein said retractable extension cord is lockable.

7. The retractable extension power cord system of claim 1 wherein said retractable extension cord further comprises a mounting bracket.

8. The retractable extension power cord system of claim 1 wherein said mounting bracket is mountable onto a vertical surface.

9. The retractable extension power cord system of claim 1 wherein said mounting bracket is mountable onto a horizontal surface.

10. The retractable extension power cord system of claim 1 wherein said receptacle is located on a boat.

11. The retractable extension power cord system of claim 1 wherein said receptacle is located on a golf cart.

12. The retractable extension power cord system of claim 1 wherein said receptacle is located on an electric car.

13. The retractable extension power cord system of claim 1 wherein said retractable extension power cord system further comprises a ground fault circuit interrupter.

14. The retractable extension power cord system of claim 13 wherein said ground fault circuit interrupter prevents output short circuit(s) from drawing excessive current.

15. The retractable extension power cord system of claim 13 wherein said ground fault circuit interrupter detects current leakage.

16. The retractable extension power cord system of claim 15 wherein said ground fault circuit interrupter interrupts a circuit if said current leakage exceeds a range of about 4-6 mA of current within about 25 ms.

17. A retractable extension power cord system comprising:
a circular, plastic housing having at least a first and a second outlet;
a retractable, reversible, lockable power cord having a male end and a female end, said male end being independently retractable out of said first outlet, said female end being accessible out of said second outlet, said female end being non-retractable;
a mounting bracket; and
a ground fault circuit interrupter;
wherein said male end is retractable out of said first outlet;
wherein said male end is directly connectable to a receptacle;
wherein said female end is directly or indirectly connectable to a power source;
wherein overall length of said retractable power cord is defined by said male end and said female end;
wherein said retractable power cord communicates power between said male end and said female end;
wherein said mounting bracket is mountable onto a vertical surface;
wherein said receptacle is located on a boat; and
wherein said ground fault circuit interrupter prevents output short circuit(s) from drawing excessive current and detects current leakage that is interrupted if said current leakage exceeds a range of about 4-6 mA of current within about 25-40 ms.

18. A method of using retractable extension power cord system comprising the steps of:
mounting a mounting bracket onto a flat surface;
retracting a male end of a retractable extension power cord out of a first outlet;
accessing a female end of said retractable extension power cord out of a second outlet;
removably connecting said male end to a receptacle;
removably connecting said female end to a power source; and
turning said retractable extension power cord system on to power said receptacle.
